(19) United States
(12) Patent Application Publication
(10) Pub. No.: US 2020/0170874 A1
(43) Pub. Date: Jun. 4, 2020

(54) Back Stretching Device

(71) Applicant: Razmik Zargarian, Glendale, CA (US)

(72) Inventor: Razmik Zargarian, Glendale, CA (US)

(21) Appl. No.: 16/208,289

(22) Filed: Dec. 3, 2018

(51) Int. Cl. A61H 1/02; A63B 21/00; A63B 21/002; A63B 21/02

(52) U.S. Cl. CPC A61H 1/0292; A61H 1/0218; A63B 21/00043; A61H 2203/0431; A63B 21/0023; A63B 21/026; A63B 21/4023; A63B 21/00185

(57) ABSTRACT

A device for strengthening the back and upper body as well as decompressing the spine is adaptive to various seated positions and methods of manipulation. The device comprises a stabilizing base, and upper crossbar joined by a central resistance member such as a spring bar extending therebetween. A gripping member such as a first and second grip or handle placed on either side of the resistance member extend from the cross bar to transfer restoring forces stored in the resistance member upward from beneath a user's armpit or shoulder joint in a manner that passively stretches the spine upward. The device is optionally operative to enable isometric as well as dynamic exercises without requiring alteration of the device itself.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to exercise devices and, more particularly, to an apparatus for spinal and upper-body stretching and strengthening devices.

### BACKGROUND

A lack of strength and general mobility through one's back and/or spinal column can negatively affect one's quality of life. For example, discomfort and lack of mobility in the back and spinal column may decrease a person's independence during middle and old age. Indeed, maintaining strength, comfort, and overall mobility in the back and upper body may reduce risk of various discomforting or even disabling injuries which may in turn reduce even a person's ability to care for oneself. Inability to maintain strength, comfort, and mobility in the back and upper body can even negatively affect one's performance of routine, daily activities such as eating, bathing, getting oneself in and out of chairs and beds, and even using the bathroom.

Some methods of enhancing strength, comfort, and mobility in the spine include, for example, spinal decompression. In general, decompression of the spine involves stretching or applying a negative force along the spine to relieve pressure on the intervertebral discs and nerves. Some non-limited benefits of doing so may include pain relief, improved circulation, improved range of motion, and realignment of the intervertebral discs. It is known that professional chiropractors may be available for engagement to physically manipulate a patient's body in order to decompress his or her spinal column. However, many devices have also been proposed to enable an individual to independently decompress or otherwise exercise his or her own back.

For example, pull-up bars commonly available on the marketplace may be suspended from doorways or mounted forward from surfaces such as walls, or even be configured as a stable, stand-alone device. In order to stretch or decompress their spine, a user may grasp a supportive bar and let some or all of his or her body weight hang for a period of time. Of course these require upper body strength and even range of motion that many in need of spinal decompression do not have.

As another example, U.S. Pat. No. 5,038,758 to Jams et al. discloses an apparatus featuring a harness and one or two foot petals in which a user sits and decompresses his or her own spine by pressing downard with his or her forearms and hands. Also a seating device, U.S. Pat. No. 5,334,123 to Rutherford discloses a tilting chair that decompresses the user's spine when he or she reclines about 30 degrees. Of course, these and similar proposals are deficient for their size, which is spatially inefficient and impractical for many people's homes.

Other examples, such as U.S. Pat. No. 9,216,311 to Champion and U.S. Pat. No. 5,462,518 to Hatley et al. which comprises resistance elements in combination with straps and belt attachments provided to secure the device to and around the body of the user. These however, are deficient as anchoring to the users own body via encircling straps can be uncomfortable and unsightly. Indeed, none of these fully address the various advantages of the present invention, and therefore, there remains a need for an improved back-stretching device.

### SUMMARY

The present disclosure is directed to an apparatus for exercising and strengthening the back muscles and even stabilizing a user's spine. Certain muscles which may be targeted by the apparatus include the latissimus dorsi and trapezius muscles. Over repeated use, and in some embodiments a single use, tension in such muscles may be reduced, the spine may be decompressed to relieve pressure on spinal or intervertebral discs, nerve pressure may be relieved, and alignment of the spine may be corrected.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the device comprises at least the following elements: a stabilizing base, an upper crossbar; a resistance member extending between and operative to connect the stabilizing base and upper cross bar; and a gripping member such as a first and second grip.

In practice, the stabilizing base may be placed on top of the user's legs in line with his or her waist crease. In some embodiments, the user may sit of the stabilizing base with the resistance member extending upward between his or her legs. Then by placing such grips under one each of the user's axilla—or armpit—the user may passively allow the device to press upward beneath his or her shoulder joints to decompress the spine and upper body. In some embodiments, the user may take each one of the grips in his or her hands and flex and/or rotate the resistance member to perform isometric exercises.

In some embodiments, the first and second grip may be repositionable along the length of the upper crossbar. It is contemplated that adjustment may make the device useable by individuals of many different sizes. For instance, a user with particularly broad shoulders may wish to adjust the first and second grip away from one another to widen the space bewteen them. In this manner, ergonomic arm placement may be achieved for many differently sized individuals. Likewise, a smaller individual may find that ergonomic use requires the grips to be placed closer together. This adjustment may be secured in various ways such as by use of a clamp, pins, friction, or some other method.

Similarly, it is contemplated that the vertical length of the device may be adjustable. Thus, users of various heights and having varying trunk lengths may benefit from the device.

Notwithstanding resiliency inherently defined by the resistance member, the base, cross bar, and gripping member may comprise durable, relatively inelastic material such as steel, durable plastics such as PVC, and/or the like. In addition, certain portions of the device may be coated in additional materials such as fabric, foam, silicone, and rubber to increase comfort and prevent injury, such as bruising. As a non-limiting example, the gripping member and stabilizing base may be wrapped or enveloped in a foam or other cushioning material to protect a user's hands and lap while he or she performs exercise or decompression using the device. As another example, in the event that the resistance member is a spring or coil, such spring or coil may be coated in rubber.

Arranging the device in this manner ensures that a user may reverse the force of gravity, effectively widening any space between the user's joints, such as, broadly, his or her hip and shoulder joints, as well as, more particularly, any space between each vertebra, and even space between each vertebra and superseding intervertebral disc.

The device is therefore configured for use as a passive, spinal traction device, operative to decompress and counteract downward forces naturally applied on an erect spine. However, it is also contemplated that the restoring force defined by the spring bar will enable desirable isometric exercises as well. Thus, the device is optionally operative to enable isometric as well as dynamic exercises without requiring alteration of the device itself

Advantages of the invention include:

Beneficial treatment or decrease of pain from physical conditions such as kyphosis, scoliosis, general back pain, herniated discs, sciatica, degenerative disk disease, spinal degenerative joint disease, spinal stenosis, spinal curvature due to tight muscles, facet syndrome, muscle tension, muscle spasms and more.

A user may be able to perform strengthening exercises with the device to aid prevention of future injury to the spine.

A user may experience an increase in upper body strength, including arm and shoulder strength, back, and abdominal strength.

A user may experience improved mobility over time.

The device is readily adaptable to the user's individual size.

The device is ergonomic.

The device avoids any need to alter doorways and other features in one's home.

The device is compact when not in use and avoids occupying significant space in one's home while not in use. Various parts may be separated from one another for easy storage.

The device is portable.

Exercises may be carried out on the device by a user at his or her own discretion with no professional or other intervention or supervision.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a perspective view of a back-stretching device in accordance with one embodiment of the invention.

FIG. 2 shows an alternative perspective view of the back-stretching device of FIG. 1.

FIG. 3 shows an exploded view of a back-stretching device in accordance with an embodiment of the invention.

FIG. 4 shows another alternative perspective view of a back-stretching device of FIG. 1.

FIG. 5 shows another alternative perspective view of a back-stretching device of FIG. 1.

FIGS. 6-8 illustrate methods of using an embodiment of the back-stretching device in accordance with some embodiments of the invention.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

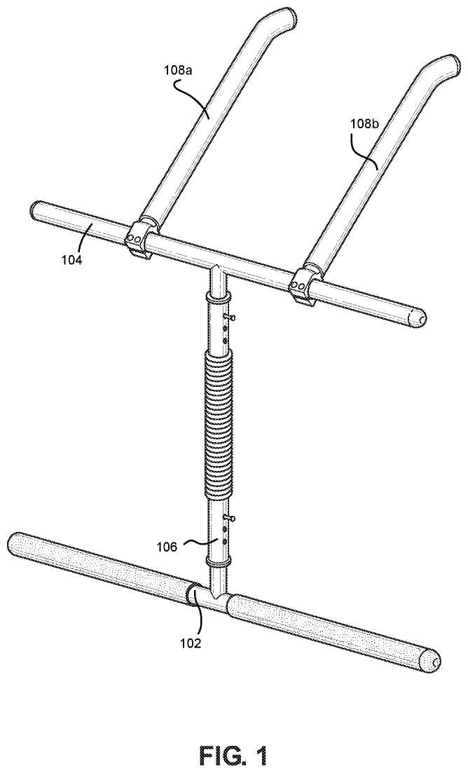

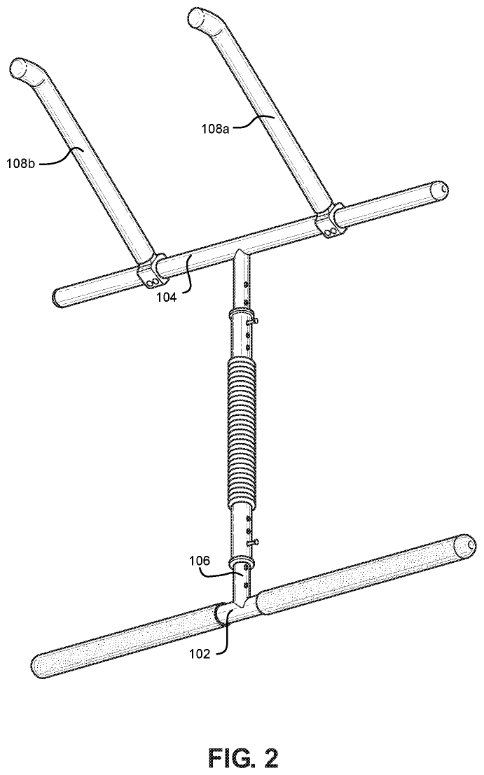

With reference to FIGS. 1 and 2, the device may comprise a stabilizing base 102, an upper cross bar 104, and a resistance member such as a spring bar 106 extending between and operative to connect the stabilizing base 102 and upper cross bar 104. A first and second grip 108a, 108b may extend perpendicular from the upper cross bar 104 from each side of resistance member 106.

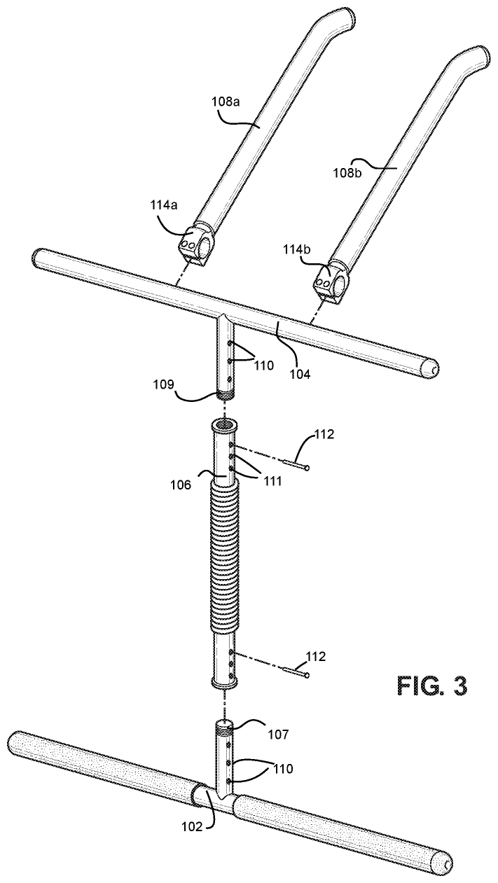

Engagement of each element relative to the others is made clearer with reference to FIG. 3. In some embodiments, elements comprising the device may be fully integrated with and inseparable from one another, such as by injection molding, welding, or another method. In some embodiments, however, each element may be fully adjustable relative to each other element so that the device may be useable by a variety of uniquely sized individuals. Thus, it may be seen that each of the stabilizing base 102 and upper cross bar 104 may define, for example, a tee-shaped tube comprising a terminal portion 107, 109 configured to threadbly mate with the resistance member 106. In some embodiments, however, (not pictured) either or each of the stabilizing base 102 and upper cross bar 104 may define a hole to receive the resistance member 106.

In some embodiments, any or all of the stabilizing base 102, upper cross bar 104, and first and second grips 108a, 108b may define hollow tubes. It is contemplated that this may decrease the overall weight of the device. In some embodiments, however, it may be desirable to increase the overall weight of the device either by filling such tubes or otherwise fabricating some or all of the elements comprising the device out of solid lengths of material. For instance, increasing the weight of the device may have additional strengthening benefits.

The vertical length of the device may be adjustable. For instance, it may be seen that the “tee” portions of the stabilizing base 102 and upper cross bar 104 define holes 110 which may align with holes 111 defined by the resistant member 106. Pins 112, buttons, depressable ridges, or other elements may be provided to engage the holes 110, 111 with one another and lock the device into a selected vertical position. Thus, users of various heights and having varying trunk lengths may use the device at a length suited to his or her own size.

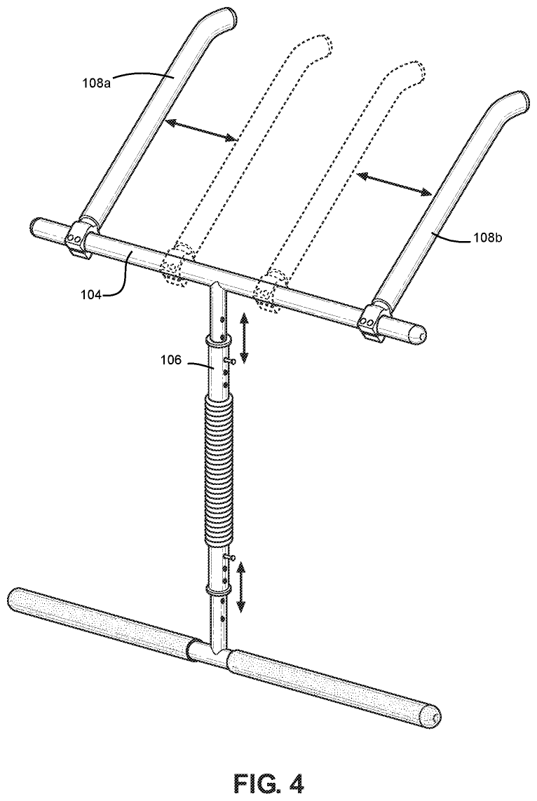

Each of the first and second grips 108a, 108b may comprise a clamping portion 114a, 114b configured to receive the upper cross bar 104 therethrough. The clamping portions 114a, 114b may then be secured by way of screws, clips, pins, frictional stoppers, or other devices in a desirable position along the length of the upper cross bar 104. This may be seen in FIG. 4. Just as the desirable vertical length of the device may depend on a user's height or trunk length, the position of the first and second grips 108a, 108b may depend for example, on the width of the user's shoulders or distance between his or her armpits. This is because setting the device to maintain the user's arm position generally in line with his or her shoulder joints may prevent additional strain on the user's body.

In order to even further accommodate users of varying sizes, the upper cross bar 104 may be relatively long compared to this distance between an average user's armpits. As such, the upper cross bar 104 may be about 18 inches to about 28 inches in length, though this may vary. Similarly, the length of the stabilizing base 102 may also be selected to accommodate users of various sizes. In some embodiments, the stabilizing base 102 may be about 20 to about 30 inches across to span the width of a vast number of potential users' hip creases and ensure hip stability while the device is in use.

It should be noted that the first and second grips 108a, 108b may be curved at an end distal to the upper crossbar 104 toward the stabilizing base 102. It is contemplated that this configuration may help a user gain leverage to manipulate the resistance member by hand over the course of isometric use. Such configuration is offered by way of example only though and not limitation. One of ordinary skill in the art will recognize that other configurations are possible to practice the invention.

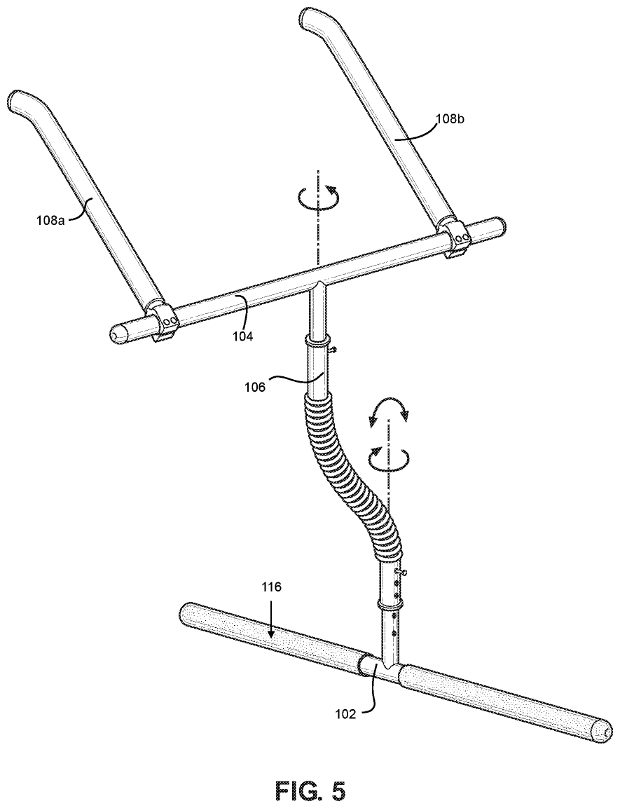

In some embodiments, the resistance member may be a spring bar comprising a coiled extension spring. The extension spring may be defined by a particular restoring force, and may even be selected based on the strength or other needs of a particular user. With reference to FIG. 5, it should be apparent that the spring bar, or resistance member 106, may be manipulated in all directions. Thus, the device may be manipulated in innumerable ways to perform strengthening and other exercises, if desired.

Further, since each element of the device is separable from and adjustable relative to one another, it is contemplated that the resistant member 106 may be interchangeable with others. For example, a spring bar may be provided which requires about 10 to about 25 pounds of force to deflect. However, in the event that additional resistance is desired, a spring bar requiring about 50, about 60 or even about 80 pounds of force to deflect may be provided.

Although the resistance member 106 may be inherently resilint, it is contemplated that the base 102, upper cross bar 104, and first and second grips 108a, 108b may comprise durable, relatively inelastic material such as steel, durable plastics such as PVC, and/or the like. In addition, certain portions of the device may be coated in additional materials such as fabric, foam, silicone, and rubber to increase comfort and prevent injury, such as bruising. As a non-limiting example, the gripping member and stabilizing base may be wrapped or enveloped in a foam or other cushioning material 116, such as that shown along the stabilizing base 102, to protect a user's hands and lap while he or she performs active exercise or even passive spinal decompression using the device. As another example, in the event that the resistance member is a spring or coil, such spring or coil may be coated in rubber.

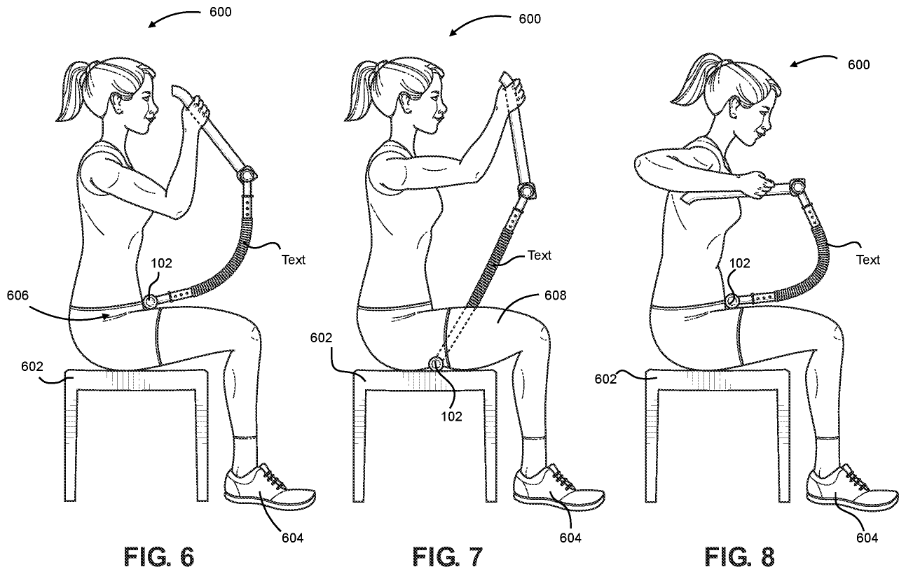

Various methods for using the device are contemplated, some of which are illustrated for clarity in FIGS. 6-8. For instance, it may be seen that a user 600 may be seated in a chair. The type of chair used will not limit the invention, however, it may be desirous that the chair have no arms in order to avoid inhibiting the user's range of motion. Thus, as seen in the image, an exemplary chair may be a stool or bench 602. The user may plant their feet 604 and the place the stabilizing bar 102 along the front of their hip crease 606. In some instances, it may not be comfortable or otherwise desirable for a user to place the bar in this manner. Therefore, it is contemplated that a user may alternatively place the stabilizing bar 102 beneath his or her hips or pelvis with the resistance member positioned between his or her legs 608 as seen in FIG. 7.

Regardless of the placement of the stabilizing bar, which is operative to prevent a user's hips from rotating significantly while using the device, in either of the exemplary positions described above, the resistance member 106 may be free to flex, extend, and/or rotate at the discretion of the user.

For example, in FIG. 8, it may be seen that the user 600 is placing the grips beneath her arms 610. When positioned thusly, the restoring force of the spring, or other embodiment of a resistant member, may extend an upward force beneath a shoulder joint through the grip held thereunder. This may cause the spine in general to stretch upward, passively resulting in beneficial decompression. In some embodiments, the user may perform active, isometric exercises with the device as well. For instance, in some embodiments, the user may maintain a hold of the grips, rather than placing them under his or her shoulder joint and press downward repeatedly and with control to engage the triceps. Maintaining the grips beneath the shoulder joints or within the axillae may enable a user to perform a seated crunch to exercise the abdominal muscles. As such, it should be clear that the device is operative to enable innumerable exercises to engage and strengthen various abdominal, arm, back and shoulder muscles in addition to providing passive decompression along the spine.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the back-stretching device and method of use with which that terminology is associated. In general, the terms used in the following claims should not be constructed to limit the back-stretching device and method of use to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the back stretching device and method of use is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the back stretching device and method of use.

What is claimed is:

1. A back stretching device, comprising:
a stabilizing base,
an upper crossbar;
a resistance member extending upward from the base to the upper cross bar; and
a first and second grip repositionable along the length of the upper crossbar;
wherein the stabilizing base, upper cross bar, and first and second grips comprise durable and inelastic material.

2. The back stretching device of claim 1, wherein the first and second grip are curved toward the stabilizing base at an end of each first and second grip distal to the upper crossbar.

3. The back stretching device of claim 1, wherein the stabilizing base and upper cross bar define hollow tee-shaped tubing operative to securely mate with a respective first and second end of the resistance member.

4. The back stretching device of claim 1 further comprising cushioning material disposed on at least a portion of the stabilizing bar.

5. The back stretching device of claim 1 further comprising cushioning material disposed on the first and second grip.

6. The back stretching device of claim 1, wherein the resistant member comprises a resilient spring bar.

7. The back stretching device of claim 6, wherein the resilient spring bar is interchangeable with alternative resistant members.

8. The back stretching device of claim 7, wherein the resilient spring bar comprises an extension spring defined by a restoring force of about 10 to about 80 pounds.

9. The back stretching device of claim 1, wherein the distance between the stabilizing bar and upper cross bar is adjustable.

10. The back stretching device of claim 1, wherein the distance between the first and second grips is adjustable.
